(19) United States
(12) Patent Application Publication
(10) Pub. No.: US 2026/0281366 A1
(43) Pub. Date: Sep. 17, 2026

(54) VIDEO SIGNAL PROCESSING DEVICE AND METHOD FOR PREDICTING CURRENT BLOCK BY USING RELATIONAL EXPRESSION BETWEEN REFERENCE BLOCK AND CURRENT BLOCK

(71) Applicant: WILUS INSTITUTE OF STANDARDS AND TECHNOLOGY INC., Gyeonggi-do (KR)

(72) Inventors: Dongcheol KIM, Gyeonggi-do (KR); Kyungyong KIM, Gyeonggi-do (KR); Juhyung SON, Gyeonggi-do (KR); Jinsam KWAK, Gyeonggi-do (KR)

(21) Appl. No.: 19/473,933

(22) PCT Filed: Apr. 16, 2024
(86) PCT No.: PCT/KR2024/005040

§ 371 Date: Oct. 9, 2025

(30) Foreign Application Priority Data
Apr. 23, 2023 (KR) 10-2023-0053049

(51) Int. Cl. H04N 19/136; H04N 19/105; H04N 19/176

(52) U.S. Cl. CPC H04N 19/136; H04N 19/105; H04N 19/176

(57) ABSTRACT

A video signal decoding device is disclosed. A video signal device comprises a processor. The processor obtains a relational expression between a template of at least one reference block referenced by at least one piece of motion information and a template of a current block, and generates a prediction block on the basis of the relational expression, the reference block, and the current block. The template of the reference block includes a sample adjacent to the reference block according to a pre-specified form. In addition, the template of the current block includes a sample adjacent to the reference block according to the pre-specified form.

### TECHNICAL FIELD

The disclosure relates to a method and an apparatus device for processing a video signal and, more particularly, to a video signal processing method and apparatus for encoding or decoding a video signal.

### BACKGROUND ART

Compression encoding refers to a series of signal processing technologies for transmitting digitized information through a communication line or storing this information in a storage medium in an appropriate form. Examples of targets of compression encoding are voice, images, text, etc., and particularly, a technology for performing compression encoding of an image is called video image compression. Compression encoding of a video signal is performed by removing surplus information in consideration of spatial correlation, temporal correlation, probabilistic correlation, etc. However, recently, as various media and data transmission media have been developed, there is an increasing need for a highly efficient method and apparatus for processing a video signal.

### DISCLOSURE OF INVENTION

### Technical Problem

This specification is to increase the coding efficiency of a video signal by providing a video signal processing method and an apparatus for the same.

### Solution to Problem

A decoding device for decoding a video signal according to an embodiment of the disclosure includes a processor. The processor obtains a relational expression between a template of at least one reference block referenced by at least one piece of motion information and a template of a current block, and generates a prediction block, based on the relational expression, the reference block, and the current block. The template of the reference block includes a sample adjacent to the reference block according to a predetermined form. In addition, the template of the current block includes a sample adjacent to the reference block according to predetermined form.

The at least one piece of motion information may be two or more pieces of motion information. In addition, the at least one reference block may be two or more blocks.

The at least one reference block may include a reference block referenced by multi-hypothesis prediction (MHP).

The relational expression may be a relational expression including a plurality of filter coefficients.

The at least one reference block may be included in a current picture including the current block.

The at least one reference block may be included in a different picture from a current picture including the current block.

A decoding device for encoding a video signal according to an embodiment of the disclosure includes a processor. The processor obtains a relational expression between a template of at least one reference block referenced by at least one piece of motion information and a template of a current block, and generates a prediction block, based on the relational expression, the reference block, and the current block. The template of the reference block includes a sample adjacent to the reference block according to a predetermined form. In addition, the template of the current block includes a sample adjacent to the reference block according to the predetermined form.

The at least one piece of motion information may be two or more pieces of motion information. In addition, the at least one reference block may be two or more blocks.

The at least one reference block may include a reference block referenced by multi-hypothesis prediction (MHP).

The relational expression may be a relational expression including a plurality of filter coefficients.

The at least one reference block may be included in a current picture including the current block.

The at least one reference block may be included in a different picture from a current picture including the current block.

In a computer-readable non-transitory storage medium storing a bitstream according to an embodiment of the disclosure, the bitstream is decoded according to a decoding method. The decoding method include obtaining a relational expression between a template of at least one reference block referenced by at least one piece of motion information and a template of a current block, and generating a prediction block, based on the relational expression, the reference block, and the current block. The template of the reference block includes a sample adjacent to the reference block according to a predetermined form. In addition, the template of the current block includes a sample adjacent to the reference block according to the predetermined form.

A decoding method for decoding a video signal according to an embodiment of the disclosure includes obtaining a relational expression between a template of at least one reference block referenced by at least one piece of motion information and a template of a current block, and generating a prediction block, based on the relational expression, the reference block, and the current block. The template of the reference block includes a sample adjacent to the reference block according to a predetermined form. In addition, the template of the current block includes a sample adjacent to the reference block according to the predetermined form.

### Advantageous Effects of Invention

This specification provides a method for efficiently processing video signals. The effects that may be acquired in this specification are not limited to the effects mentioned above, and other effects not mentioned may be clearly understood by a person skilled in the art from the description below.

### BRIEF DESCRIPTION OF DRAWINGS

FIG. 1 is a schematic block diagram of a video signal encoding apparatus according to an embodiment of the disclosure;

FIG. 2 is a schematic block diagram of a video signal decoding apparatus according to an embodiment of the disclosure;

FIG. 3 illustrates an embodiment in which a coding tree unit is divided into coding units within a picture;

FIG. 4 illustrates an embodiment of a method for signaling splitting of quad trees and multi-type trees;

FIGS. 5 and 6 illustrate an intra-prediction method according to an embodiment of the disclosure in more detail;

FIG. 7 illustrates the positions of neighboring blocks used to generate a motion candidate list in inter-prediction;

FIG. 8 is a diagram illustrating prediction of a sample of a current block using a convolutional model according to an embodiment of the disclosure.

FIG. 9 is a diagram illustrating generation of a prediction block by applying a filter model to IBC block prediction according to an embodiment of the disclosure.

FIG. 10 is a diagram illustrating generation of a prediction block by calculating a weighted sum of reference blocks that a video signal processing device refers to in bi-directional prediction, when the video signal processing device predicts a current block in bi-directional prediction according to an embodiment of the disclosure.

FIG. 11 is a diagram illustrating generation of a prediction block using a weighted sum of a current block of a uni-directional prediction block and a multi-hypothesis prediction (MHP) block, by a video signal processing device according to an embodiment of the disclosure.

FIG. 12 is a diagram illustrating generation of a prediction block by calculating a weighted sum of reference blocks that a video signal processing device refers to in bi-directional prediction and an MHP reference block when the video signal processing device predicts a current block in bi-directional prediction according to an embodiment of the disclosure.

FIG. 13 is a diagram illustrating generation of a prediction block by calculating a weighted sum of reference blocks that a video signal processing device refers to in inter bi-directional prediction when the video signal processing device predicts a current block in inter bi-directional prediction according to an embodiment of the disclosure.

FIG. 14 is a diagram illustrating a method of performing GPM blending by a video signal processing device according to an embodiment of the disclosure.

### MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luma”, “Y”, and the like may be used interchangeably in this specification. Additionally, in the present specification, the terms “chroma”, “chroma”, “Cb or Cr”, and the like may be used interchangeably, and chroma components are classified into two components, Cb and Cr, and thus each chroma component may be distinguished and used. Additionally, in this specification, the term “sample” refers to a fundamental element that constitutes a picture or frame. When the value of a luma sample is represented using 8 bits, it can range from 0 to 255, and when represented using 12 bits, it can range from 0 to 4095. The terms “sample,” “pixel,” and “picture element” may be used interchangeably. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

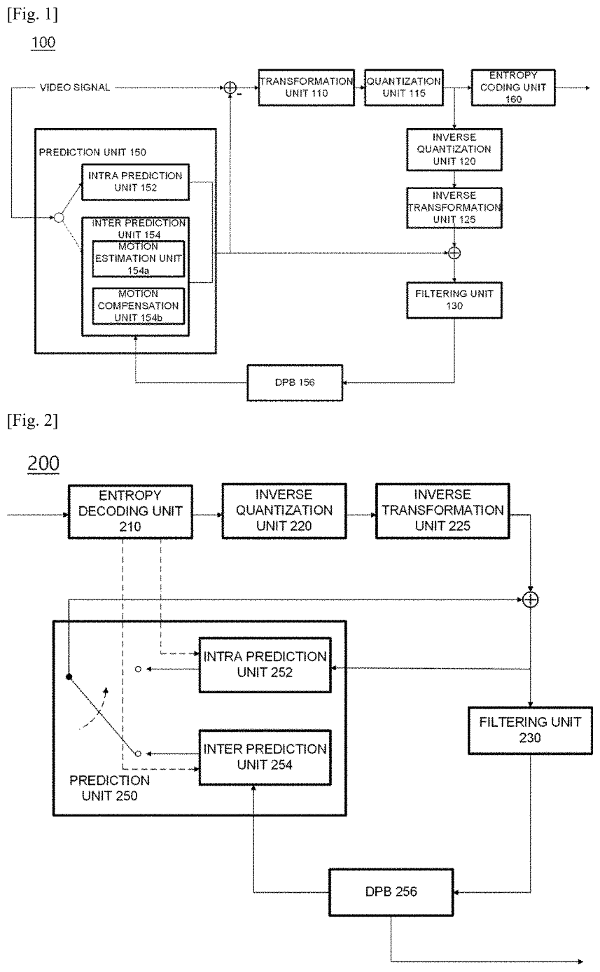

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

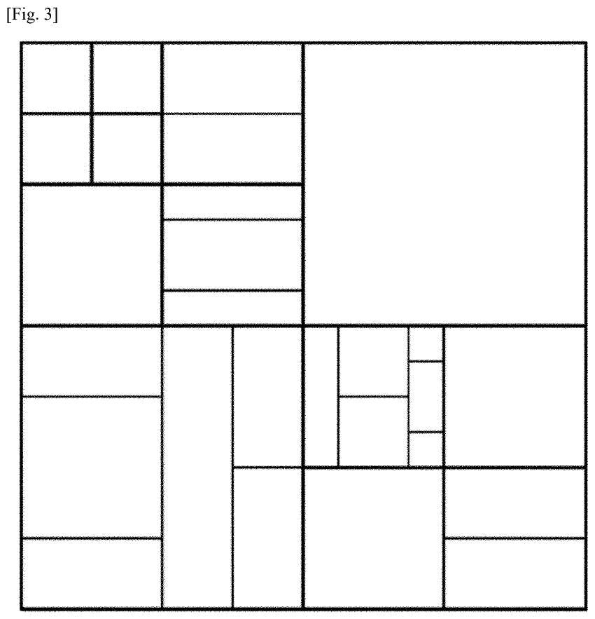

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

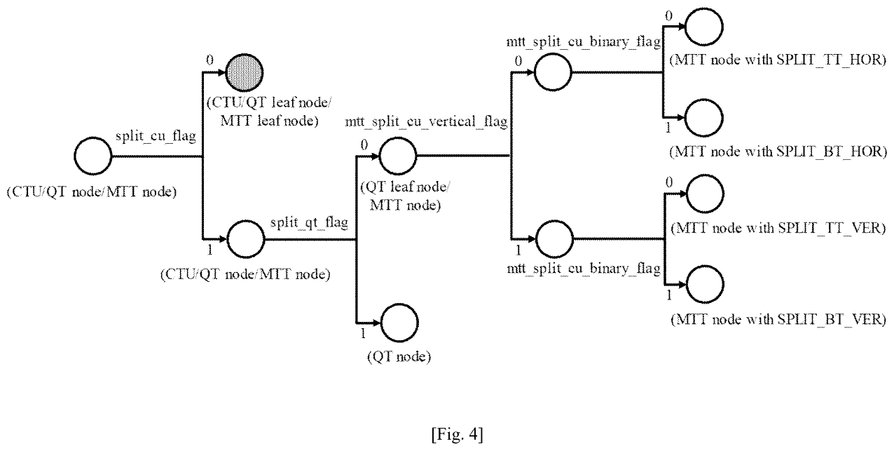

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

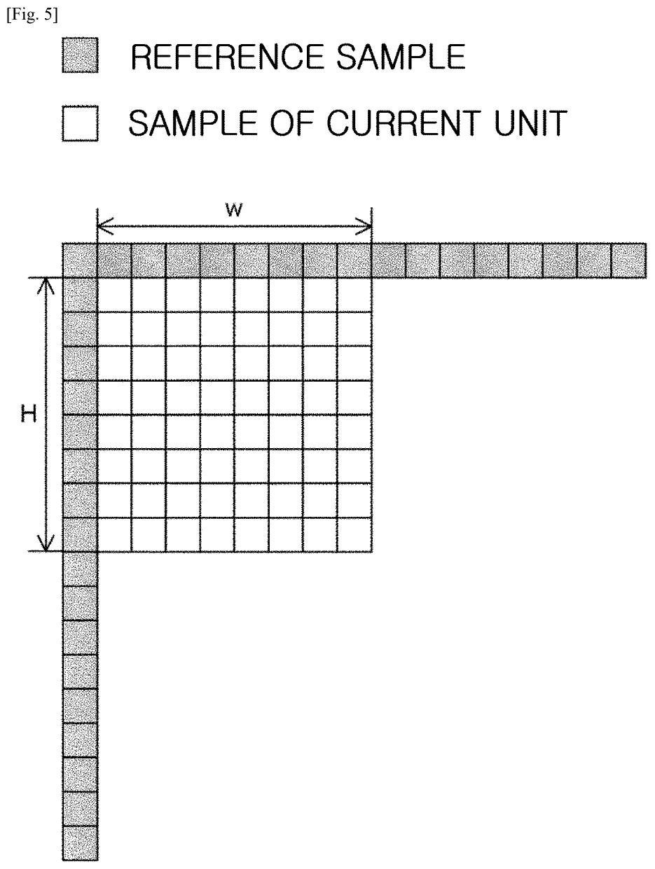

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra coding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

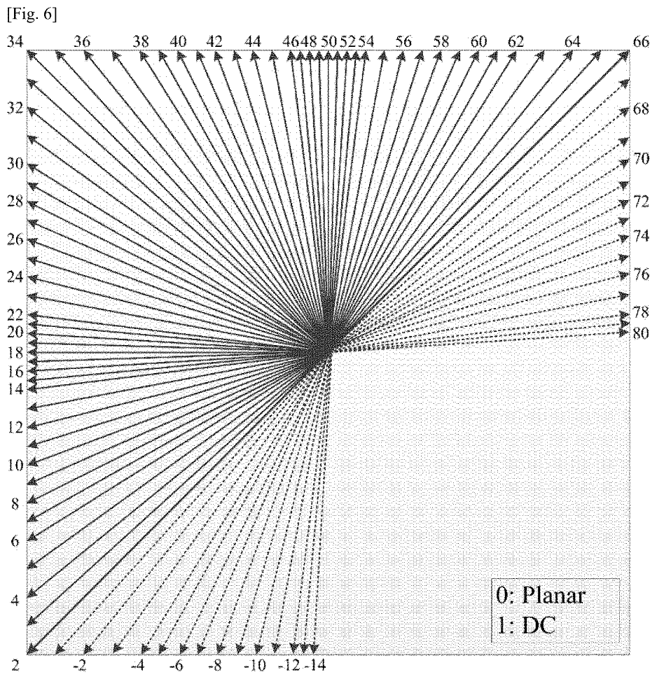

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than-135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_l0, ref_idx_l1), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_l0_flag, mvp_l1_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

The motion candidate and the motion information candidate of this specification may have the same meaning. In addition, the motion candidate list and the motion information candidate list of this specification may have the same meaning.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM). In addition, like the CCLM and MMLM, a prediction method using correlations between different signals may be called cross-component prediction (CCP). The CCLM uses one linear model, and thus it may be called a single CCP model, and the MMLM uses multiple linear models, and thus it may be called a multi (or complex) CCP model.

The encoder and decoder may construct a reconstructed luma block by adding the luma prediction block of the current block and the error signal for the luma block, and then construct a CCP model by using the correlation between the reconstructed luma block and the luma prediction block. Here, the CCP model may be one of CCLM, MMLM, GLM, CCCM, MM-CCCM, GL-CCCM, CCCM-ND, and CCCM-MDF. The CCP model derived from the luma block may be applied to the chroma prediction block to generate a first chroma prediction block to which the CCP model is applied. A final chroma block may be generated by adding the error signal for the chroma block and the first chroma prediction block.

In addition, the CCP model is understood as meaning that at least one type of CCP model among the types of the CCP model is used. The CCP model may be configured by at least one CCP model. One CCP model may be configured by two CCLMs, and this may be referred to as MMLM. A new CCP model may be a different type of CCP model, or a model with the same type of CCP model but different parameter values. When the types of CCP models are different between CCP models, they may be called different CCP models. When the type of CCP model is the same between CCP models, but the parameters between CCP models are different, they may be called different CCP models. When the number of CCP models is different between CCP models (for example, when the first CCP model is configured by one CCLM and the second CCP model is configured by two CCLMs), they may be called different CCP models. The CCP model may include at least one of type information of the CCP model, parameter information of the CCP model, information on whether a multi-CCP such as MMLM or MM-CCCM were used, information on the average value of the luma block, and down-sampling filter information.

Convolutional cross-component model (CCCM) is a method of constructing a non-linear model by using the correlation between a luma signal and a chroma signal located at the same position as the luma signal, and then predicting the chroma signal by using the non-linear model.

Gradient linear model (GLM) is a method of constructing a model by additionally reflecting the gradient of the luma sample to a linear model such as CCLM, and then predicting the chroma signal by using the model.

Multi-model CCCM (MM-CCCM) is a method of deriving two CCCM parameters based on an average value of a reference area (or a reconstructed current luma block).

Gradient and location based convolutional cross-component model (GL-CCCM) is an additional CCCM mode using gradient and location information. The existing CCCM mode may derive a chroma sample for the current block by using a luma sample at the position corresponding to the chroma sample to be predicted, four samples around the luma sample, and coefficient information. Here, the GL-CCCM mode may derive a chroma sample for the current block by using the luma sample at the position corresponding to the chroma sample to be predicted, the vertical and horizontal differences for the 8 samples around the luma sample, the horizontal and vertical coordinates of the current luma sample, and the coefficient information of the prediction model.

In CCCM, which predicts the chroma block based on the luma block, it is necessary to lower the resolution of the luma block to that of the chroma block in order to match the resolution difference between the luma block and the chroma block. Here, various down-sampling filters may be applied. This mode may be referred to as CCCM with multiple down-sampling filters (CCCM-MDF).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

A block predicted by using the intra prediction directional mode may have discontinuous edges at the above and left boundaries of the block. For example, if the current block is predicted by using vertical direction mode, discontinuous edges may exist at the left boundary of the block. To mitigate this discontinuity, the encoder and decoder may apply filtering to the samples at the boundary inside the prediction block. The filtering may determine whether to apply the filtering and/or the filtering weight by using at least one of a reconstructed sample adjacent to the current prediction block, location information of the reconstructed sample adjacent to the current prediction block, a sample at a boundary inside the current prediction block, location information of the sample at a boundary inside the current prediction block, the intra prediction directional mode of the current prediction block, and the horizontal size and the vertical size of the current prediction block. The filtering weight refer to the weight for a sample at a boundary inside the current prediction block and the weight for a reconstructed sample adjacent to the current prediction block. This filtering method may be referred to as position dependent prediction combination (PDPC).

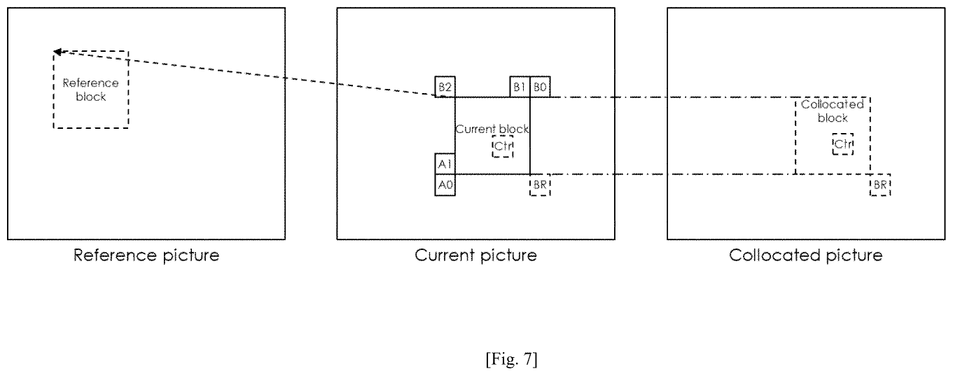

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

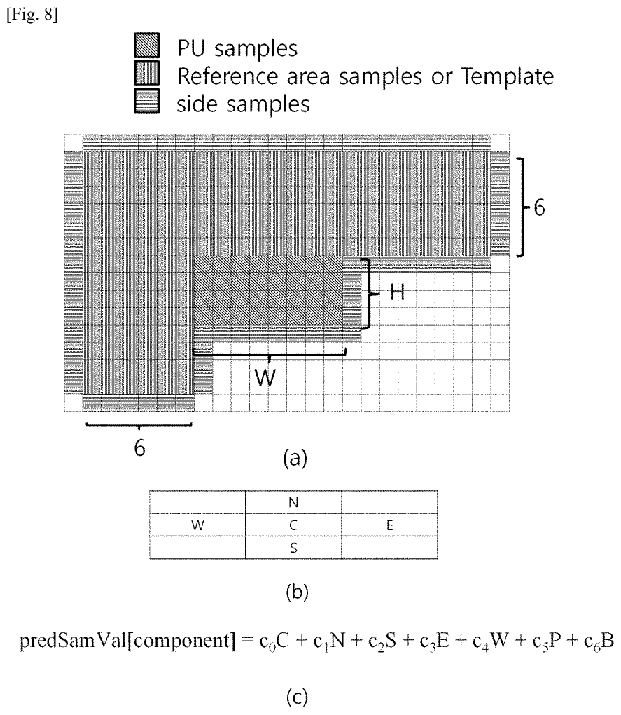

FIG. 8 is a diagram illustrating prediction of a sample of a current block using a convolutional model according to an embodiment of the disclosure.

A video signal processing device may obtain a convolutional model by deriving a filter relational expression between a template of a current block and a template of a reference block. The video signal processing device may predict the current block using the obtained convolutional model. The convolutional model may include a plurality of filter coefficients. In this instance, the number of filter coefficients may be predetermined. In addition, according to another embodiment, the number of filter coefficients may be variable. The video signal processing device may obtain, as a filter coefficient of the convolutional model, a coefficient that minimizes a mean square error (MSE) between the template of the current block and a value obtained by applying the template of the reference block to the convolutional model. In this instance, the video signal processing device may obtain the filter coefficient of the convolutional model using Cholesky decomposition or LDL decomposition. Specifically, in a matrix operation of Ax=B, x may be obtained using an x=B/A operation. To decompose matrix A in order to calculate 1/A, Cholesky decomposition or LDL decomposition may be used.

In Cholesky decomposition, a symmetric matrix may be decomposed into a product of a lower triangular matrix or upper triangular matrix and its transpose. In LDL decomposition, a symmetric matrix may be decomposed into a product of a lower triangular matrix or upper triangular matrix, a diagonal matrix, and the transpose of the lower triangular matrix. In the lower triangular matrix, elements exist only below the diagonal matrix and only elements of 0 exist above the diagonal matrix. Unlike the lower triangular matrix, in the upper triangular matrix, elements exist only above the diagonal matrix and only elements of 0 exist below the diagonal matrix. In the matrix operation Ax=B, A may be a value of a luma template of the reference block. B may be a value of a luma template of the current block. According to another embodiment, A may be the value of the luma template of the current block and B may be the value of the luma template of the reference block. Specifically, the video signal processing device may obtain an autocorrelation matrix for A and may obtain a cross-correlation vector between A and B. The autocorrelation matrix may be decomposed via LDL decomposition. This may be expressed as the following equation.

$${U}^{′} * D * U * x = B$$

U denotes an upper triangular matrix, D denotes a diagonal matrix, and U′ denotes the transposed matrix of U. The video signal processing device may obtain a filter coefficient by applying back substitution of Gauss-Jordan elimination to the matrix relational expression.

In FIG. 8, (a) illustrates a location of a template used for obtaining a convolutional model according to an embodiment of the disclosure. Samples marked as reference area samples are samples of the template. The form and the location of the template of the current block may be the same as the form and the location of the template of the reference block. In addition, a size of the template may be defined variously.

When a size of the current block is W (width)×H (height), the size of the template may be 2W×n+2H×n+n×n. n is a predetermined value. The value of N may be an integer greater than or equal to 1. For example, the value of n may be 6. Side samples may be located outside a boundary of the template and the current block. In (a) of FIG. 8, they are shown as samples marked by horizontal lines. In FIG. 8, (b) illustrates a location of a sample used for a convolutional model when a sample at location C is predicted according to an embodiment of the disclosure. In FIG. 8, (c) illustrates a convolutional model according to an embodiment of the disclosure. The value of a sample corresponding to the location of the sample indicated by (b) in FIG. 8 may be applied to the convolutional model in (c) of FIG. 8. When a sample used for the convolutional model is beyond a template area, the video signal processing device may need an additional sample in addition to the template, in order to apply a sample value to the convolutional model. In this instance, the video signal processing device may perform padding with a value of one of the samples in the template area. Specifically, the location of the sample may be any one of the locations of the samples used for the convolutional model. The location of any one of the samples may be C indicated by (b) in FIG. 8.

The template may be configured for each component. Specifically, a template corresponding to a luma sample and a template corresponding to a chroma sample may be configured separately. When the ratio of luma samples and the ratio of chroma sample are the same, a template form corresponding to the luma samples, for example, a size and a shape, may be the same as a template form corresponding to the chroma samples. When the luma samples and the chroma samples have different ratios, the template form corresponding to the luma samples, for example, a size and a shape, may be different from the template form corresponding to the luma samples.

The number of filters of the convolutional model may be 7. The number of filter coefficients of the convolutional model may include 5 neighboring samples in a cross shape as shown in (b) of FIG. 8, one non-linear element, and one bias element. C in (b) of FIG. 8 is a predicted current sample which is located in the center, N is a sample located above the current prediction sample C, S is a sample located below the current prediction sample C, W is a sample located on the left of the current prediction sample C, and E is a sample located on the right of the current prediction sample C. It may be expressed as a relational expression using a portion or the all of the filter coefficients, as shown in (c) of FIG. 8. A predicted sample value in (c) of FIG. 8 may be obtained for each component (luma, Cr, and Cb). Each filter coefficient value may be different for each component.

In (c) of FIG. 8, P is a linear element and may be obtained for each component according to the following equations. A bit depth (bitDepth) is a depth of a bit for each component, and may have a positive integer value. The bit depth may be one of 8, 10, and 12.

The video signal processing device may perform the following operation for each component based on the sample value of location C in (b) of FIG. 8, so as to obtain the value of P. In this instance, bitDepth denotes a bit depth, C_{Luma} denotes a luma component sample at location C, C_{Cb} denotes a chroma Cb component sample at location C, and C_{Cr} denotes a chroma Cr component sample at location C. In addition, <<and>> are bit shift operators.

$$P = ( {C}_{Luma} * {C}_{Luma} + 1 << ( bitDepth - 1 ) ) >> bitDepth$$

$$P = ( {C}_{Cb} * {C}_{Cb} + 1 << ( bitDepth - 1 ) ) >> bitDepth$$

$$P = ( {C}_{Cr} * {C}_{Cr} + 1 << ( bitDepth - 1 ) ) >> bitDepth$$

The video signal processing device may perform the following operation based on a mean value (meanSamples) of all samples (N, W, S, E, C) for each component in (b) of FIG. 8, so as to obtain the value of P. meanSamples_{Luma} denotes a mean value of all luma component sample values, meanSamples_{Cb} denotes a mean value of all chroma Cb component sample values, and meanSamples_{Cr} denotes a mean value of all chroma Cr component sample values.

$$P = ( {meanSamples}_{Luma} * {meanSamples}_{Luma} + 1 << ( bitDepth - 1 ) ) >> bitDepth$$

$$P = ( {meanSamples}_{Cb} * {meanSamples}_{Cb} + 1 << ( bitDepth - 1 ) ) >> bitDepth$$

$$P = ( {meanSamples}_{Cr} * {meanSamples}_{Cr} + 1 << ( bitDepth - 1 ) ) >> bitDepth$$

The video signal processing device may perform the following operation based on a mean value (meanY, meanCb, meanCr) of the samples of the template in (a) of FIG. 8 for each component, and may obtain the value of P.

$$P = ( meanY * meanY + 1 << ( bitDepth - 1 ) ) >> bitDepth ,$$

$$P = ( meanCb * meanCb + 1 << ( bitDepth - 1 ) ) >> bitDepth ,$$

$$P = ( meanCr * meanCr + 1 << ( bitDepth - 1 ) ) >> bitDepth$$

B in (b) FIG. 8 may be a bias value and may be expressed as an integer value. In this instance, the bias may be an offset. Specifically, the value of B may be a median value of a bit depth for each component. For example, when the bit depth is 10 bits, the value of B may be 512.

The relational expression in (c) of FIG. 8 may be configured with sample values at predetermined locations as shown in (b) of FIG. 8 and the values of P and B obtained according to the above-described embodiment. In addition, the sample value used for obtaining the coefficient in the relational expression in (c) of FIG. 8 may be a value obtained by subtracting a predetermined value from a sample value. Specifically, the coefficient of the relational expression may be obtained according to the following equation. In this instance, midValue denotes a median value of a bit depth for each component.

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonL inear ( {C}^{′} )$$

$$B = midValue = 1 << ( bitDepth - 1 )$$

In addition, the filter relational expression in (c) of FIG. 8 may further include a predetermined offset value.

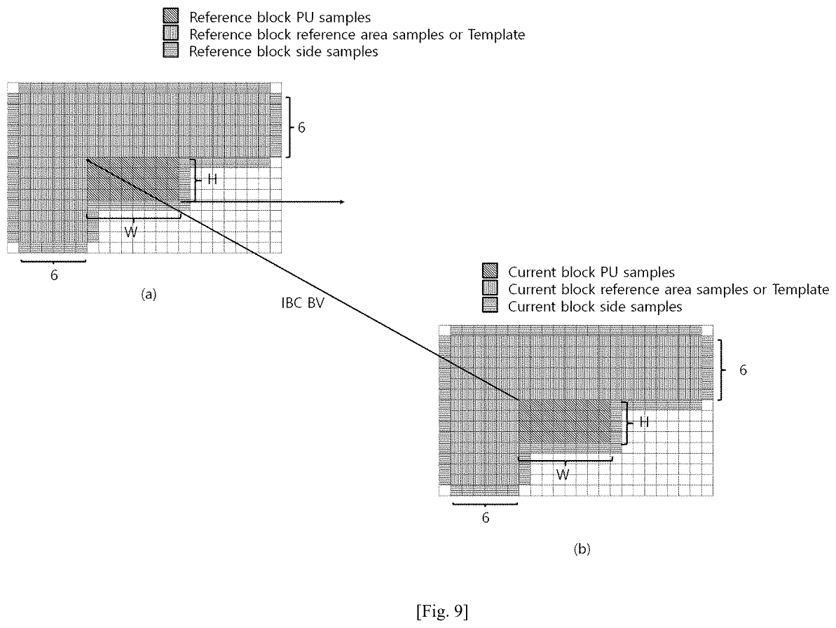

FIG. 9 is a diagram illustrating generation of a prediction block by applying a filter model to IBC block prediction according to an embodiment of the disclosure.

In IBC, a video signal processing device may use a reference block corresponding to a block vector as a prediction block. In this instance, the video signal processing device may generate a prediction block by applying, to the reference block, a filter model described with reference to FIG. 8. Specifically, the video signal processing device may derive a filter model using a relationship between a sample of a template of the reference block and a sample of a template of a current block. The video signal processing device may generate a prediction sample of the current block by applying the derived filter model to the sample of the reference block. The video signal processing device may derive a filter model for each component (Y, Cb, Cr) of an IBC block, and may apply the filter model for each component. According to another embodiment, the video signal processing device may apply a filter model only for a luma component. The video signal processing device may obtain a filter model using a luma component, and may apply the obtained filter model to all components. According to another embodiment, the video signal processing device may derive a filter model for any one of luma and chroma components, and may apply the derived filter model to the corresponding component.

A prediction mode of a prediction block to which IBC is applied may be configured as MODE_IBC. When IBC is applied to a prediction block, a bitstream may include a flag indicating whether the above-described filter model is applied to the prediction block. For ease of description, the flag is referred to as IBCFilterFlag. The number of IBCFilterFlag for each prediction block may be different according to a filter model application method. The bitstream may include IBCFilterFlag indicating whether a filter model is applied to all components for one prediction block. According to another embodiment, the bitstream may include a plurality of IBCFilterFlag indicating whether a filtering model is indicated for each component for one prediction block. In this instance, IBCFilterFlag may be parsed for each component. In addition, the bitstream may include IBCFilterFlag for each of Y, Cb, and Cr. According to another embodiment, the bit stream may include a flag indicating whether a filter model is applied to a luma component of a prediction block, and a flag indicating whether a filter model is applied to a chroma component of the prediction block. In this instance, the video signal processing device may parse IBCFilterFlag for the luma component of the prediction block and IBCFilterFlag for the chroma component of the prediction block, respectively.

In addition, the bitstream may not include IBCFilterFlag for a block to which IBCCIIP or IBCGPM is applied. In this instance, the video signal processing device may infer, to be a predetermined value, the value of IBCFilterFlag for the block to which IBCCIIP or IBCGPM is applied. In this instance, the predetermined value may be a value indicating that a filter model is not applied. In addition, the predetermined value may be 0.

According to another embodiment, the video signal processing device may predict an intra prediction block used for CIIP in IBCCIIP prediction by using an IBC filter model. The video signal processing device may predict an intra prediction block used in IBCGPM prediction by using an IBC filter model. When IBCFilterFlag indicates that a filter model is used for a prediction block, a bitstream may not include a flag indicating whether LIC is applied to a prediction block. For ease of description, the corresponding flag is referred to as IbcLicFlag. When IBCFilterFlag indicates that a filter model is applied to a prediction block, the video signal processing device may infer the value of IbcLicFlag to be a predetermined value. In this instance, the predetermined value may indicate that LIC is not applied to a prediction block. In addition, the predetermined value may be 0.

According to another embodiment, when IBC is used for predicting a prediction block, a filter model may always be applied for predicting a prediction block.

The filter model may also be applied to a general inter prediction block, and an indicator indicating whether the filter model is applied may be signaled/parsed. The method described with reference to FIG. 8 may be applied.

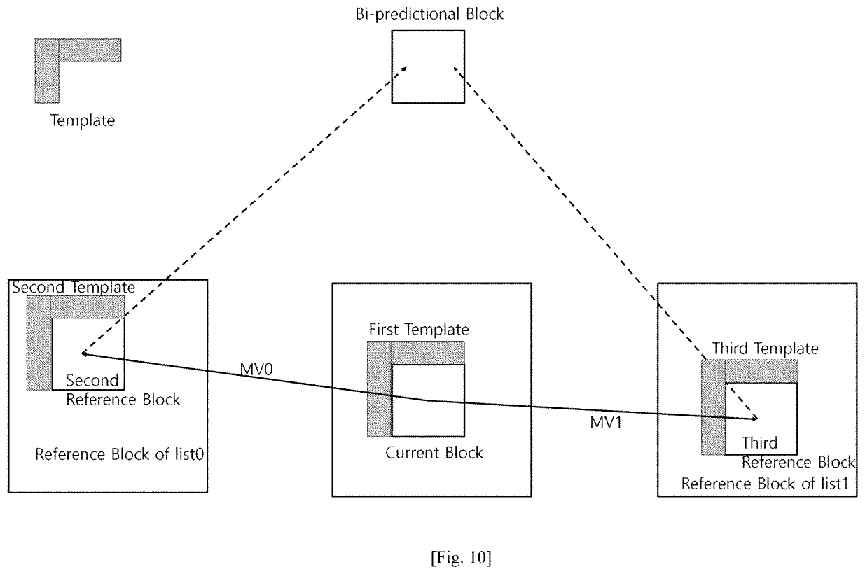

The video signal processing device according to an embodiment of the disclosure may obtain a relational expression between a template of at least one reference block referenced by at least one motion information and a template of a current block. In this instance, the video signal processing device may generate a prediction block based on the relational expression, the reference block, and the current block. In this instance, the template of the reference block may include a sample adjacent to the reference block according to a predetermined form. In this instance, the template of the current block may include a sample adjacent to the reference block according to the predetermined form. In this instance, the form of the template may be the same as the form of the template for CCCM described with reference to FIG. 9. The template form may include at least one from among L-shape, Left only, and Above only. In the following description, the L-shape template may be used as an example. In the following embodiments described below, unless otherwise indicated, a template form may be the same as the template form for CCCM that has been described with reference to FIG. 9. The embodiments will be described with reference to FIGS. 10 to 13.

FIG. 10 is a diagram illustrating generation of a prediction block by calculating a weighted sum of reference blocks that a video signal processing device refers to in bi-directional prediction when the video signal processing device predicts a current block in bi-directional prediction according to an embodiment of the disclosure.

When generating a prediction sample using different predictors in an inter prediction mode, the video signal processing device may derive a prediction value by calculating a weighted sum of a sample of a first reference block and a sample of a second reference block. In this instance, a weight used for the weighted sum may be referred to as a bi-predicted weight (BCW). The video signal processing device may select a BCW value from {1,2,3,4,5,6,7} for use. Specifically, when the video signal processing device performs prediction in a merge mode, the video signal processing device may select the BCW value from {1,2,3,4,5,6,7} for use. When the video signal processing device performs inter prediction not in a merge mode, the video signal processing device may select the BCW value from {1,7} for use. An encoder may signal the BCW value using an BCW index. A decoder may parse the BCW index from a bitstream, and may select the BCW value.

According to another embodiment, the video signal processing device may select a weight that minimizes a template matching (TM) cost value to be the BCW value. For ease of description, it is referred to as a TM-based BCW index deriving scheme. The video signal processing device may use a TM-based BCW index deriving scheme from a normal merge mode, a TM mode, an adaptive DMVR mode, and an MMVD mode. When a bi-directional prediction (bi-predictive prediction) is performed in an IBC MODE, the video signal processing device may perform encoding by assuming that a prediction sample is generated using a BCW value determined using the TM-based BCW index deriving scheme. In addition, the decoder may generate a prediction sample using the BCW value determined using the TM-based BCW index deriving scheme.

The video signal processing device may generate a prediction block by calculating a weighted sum of reference blocks referenced in bi-directional prediction. Specifically, the video signal processing device may derive a relational expression between a template of the current block and a template of the reference block, and may generate a prediction block using the derived relational expression. In this instance, the video signal processing device may apply a weight based on a sample unit for each reference block or based on a block unit. Therefore, a weight may be different for each reference block but one weight may be applied in each reference block.

When the video signal processing device may generate a prediction block of the current block using a plurality of reference blocks referenced by a plurality of pieces of motion information, the video signal processing device may generate a prediction block by calculating a weighted sum of the plurality of reference blocks. In this instance, in order to obtain a relational expression between the current block and the reference block used for the weighted sum, the video signal processing device may use a template including a sample adjacent to the current block and a template including a sample adjacent to the reference block. In this instance, the form of the template may be the same as the form of the template for CCCM that has been described with reference to FIG. 9. The template form may include at least one from among L-shape, Left only, and Above only. In the following description, the L-shape template may be used as an example. In the embodiments described below, unless otherwise indicated, the template form may be the same as the template form for CCCM that has been described in FIG. 9.

The template including a sample adjacent to the current block is referred to as a first template. When bi-directional prediction is used, two pieces of motion information (MV0, MV1) may be used. The template including a sample adjacent to the reference block referenced by MV0 motion information is referred to as a second template. The template including a sample adjacent to the reference block referenced by MV1 motion information is referred to as a third template. The video signal processing device may obtain coefficients of the relational expression using the above-described first to third templates. For example, the relational expression may be expressed as shown in the following equation.

$$predSample = a 0 * P 1 + a 1 * P 2 + a 2 * offset ,$$

predSample denotes a sample value of the current block. In this instance, a0, a1, and a2 are filter coefficients. In addition, P1 and P2 may be values obtained based on a plurality of reference blocks. For example, P1 may be a sample value of the second reference block. In addition, P2 may be a sample value of the third template. Offset may be a median value of a bit depth of an image. When a bitstream is associated with an image with a 10-bit depth, Offset may be 512. According to another embodiment, Offset may be a mean value of samples included in a template of any one of the reference blocks or may be a mean value of samples included in the plurality of reference blocks. In this instance, the number of the plurality of reference blocks may be 2. According to another embodiment, Offset may be a predetermined value. According to another embodiment, the relational expression may be replaced with the following relational expression.

$$predSample ( x , y ) = a 0 * P 1 + a 1 * P 2 + a 2 * x + a 3 * y + a 4 * offset$$

In this instance, x and y represent an x coordinate and a y coordinate of the current sample, respectively, and may be a relative location with respect to top-left coordinates of a template or reference block.

In addition, a final result value of the above-described relational expressions may be one of weights, instead of a prediction sample value of the current block. In this instance, the relational expression may be expressed as shown below.

$$First weight ( x , y ) = a 0 * P 1 + a 1 * P 2 + a 2 * x + a 3 * y + a 4 * offset$$

When two weights (first weight, second weight) are used, the second weight may be 1—the first weight. In this instance, a final prediction sample value may be expressed as shown below. The final prediction sample value may be expressed as shown below.

$$Final prediction sample value = mean value of ( weight \times P 0 + ( 1 - weight ) \times P 2 )$$

The video signal processing device may apply the above-described embodiments to bi-directional prediction of intra block copy (IBC). Specifically, in bi-directional prediction of IBC, the video signal processing device may derive a relational expression using reference blocks based on two pieces of motion information, templates of the reference blocks, and a template of the current block. In this instance, the video signal processing device may generate a final prediction sample using the derived relational expression.

The video signal processing device may obtain filter coefficients of the equation using the template of the current block and the templates of the plurality of reference blocks. Specifically, the video signal processing device may apply a sample value of the template of the current block to a value of predSample, and may apply sample values of the templates of the plurality of reference blocks to P1 and P2, respectively, so as to obtain filter coefficients. For example, the video signal processing device may obtain the filter coefficients of the equation by applying a sample value of the first template to the value of predSample, a sample value of the second template to P2, and a sample value of the third template to P3. This may be similar to the method of deriving a filter coefficient in CCCM that has been described with reference to FIG. 8. The video signal processing device may obtain a sample value of the current block by applying a sample value of a reference block to the derived relational expression. The embodiments for obtaining a filter coefficient may replace the embodiments for signaling a BCW value via a BCW index. Specifically, when a value of a BCW flag is a predetermined value, for example, true, a filter coefficient value may be derived.

Although the above-described embodiments are bi-directional prediction, the remaining operations excluding weighted combination in the embodiments may also be equally applied to a method of generating a prediction block using uni-directional prediction. Filter coefficients that have been used may be reused in a uni/bi-directional block later. BCW may be applied according to the embodiments even when bi-directional prediction (bi-predictive prediction) is performed in the IBC mode.

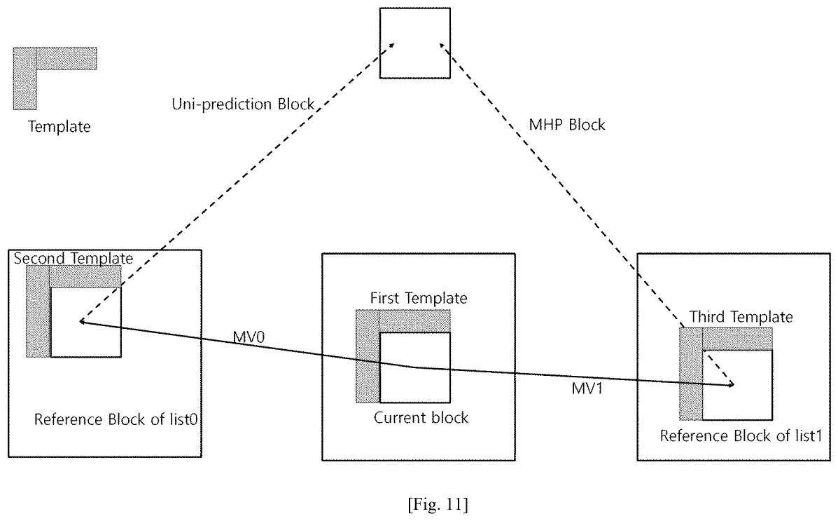

FIG. 11 is a diagram illustrating generation of a prediction block using a weighted sum of a current block of a uni-directional prediction block and a multi-hypothesis prediction (MHP) block, by a video signal processing device according to an embodiment of the disclosure.

When the video signal processing device performs MHP, one or more additional motion-compensated prediction signals may be used. In this instance, the video signal processing device may use a sample unit-based weighted sum. Specifically, the video signal processing device may perform a sample unit-based weighted sum using the following equation.

$${P}_{n + 1} = ( 1 - {α}_{π + 1} ) * {P}_{n} + {α}_{n + 1} * {h}_{n + 1}$$

Pₙ denotes a uni-prediction signal or bi-prediction sample. hₙ₊₁ denotes a sample added by MHP. α denotes a weight. Weight α may be as shown in the table below, and may be indicated by add_hyp_weight_idx.

| Add_hyp_weight_idx | α |
|---|---|
| 0 | ¼ |
| 1 | -⅛ |

When the video signal processing device generates a prediction block using a reference block referenced by motion information and a reference block added by MHP, the video signal processing device may generate a prediction block by calculating a weighted sum of the reference block referenced by the motion information and the reference block added by MHP. Specifically, the video signal processing device may derive a relational expression among a template included in the reference block referenced by the motion information, a template included in the reference block added by MHP, and a template of a current block, and may predict the current block using the derived relational expression. The video signal processing device may apply a weight based on a sample unit for each reference block or based on a block unit. Therefore, a weight may be different for each reference block but one weight may be applied in each reference block.

In addition, a plurality of reference blocks may include a reference block referenced by motion information which may be used for uni-directional prediction, and reference blocks referenced by MV0, motion information used for additional prediction block of MHP, and MV1. A template including a sample adjacent to the current block is referred to as a first template. In addition, a template including a sample adjacent to the reference block referenced by MV0 is referred to as a second template. A template including a sample adjacent to the reference block referenced by MV1 is referred to as a third template. Specifically, the reference block referenced by MV1 may be an additional reference block of MHP. The video signal processing device may obtain coefficients of the relational expression using the above-described first to third templates. For example, a filter equation may be as shown below.

$${P}_{n + 1} = ( {α}_{0} ) * {P}_{n} + {α}_{1} * {h}_{n + 1} + {α}_{2} * offset$$

Pₙ₊₁ denotes a sample value of the current block α₀, α₁, and α₂ may be filter coefficients. Pₙ denotes a sample value of the reference block referenced by MV0, and hₙ₊₁ denotes a sample value of the reference block referenced by MV1. Offset may be a median value of a bit depth of an image. When a bitstream is associated with an image with a 10-bit depth, Offset may be 512. According to another embodiment, Offset may be a mean value of samples included in the template of any one of the reference blocks or may be a mean value of samples included in the plurality of reference blocks. In this instance, the number of the plurality of reference blocks may be 2. According to another embodiment, Offset may be a predetermined value.

The video signal processing device may obtain filter coefficients of the equation using the template of the current block and the templates of the plurality of reference blocks. Specifically, the video signal processing device may apply a sample value of the first template to a value of Pₙ₊₁, and may apply sample values of the templates of the plurality of reference blocks to P1 and P2, respectively, so as to obtain filter coefficients. Specifically, the video signal processing device may apply a sample value of the second template to Pₙ and may apply a sample value of the third template to hₙ₊₁. The video signal processing device may obtain filter coefficients α₀, α₁, and α₂ according to the embodiments. In this instance, Offset may be determined according to the above-described embodiments. In addition, the operation may be the same as a method of deriving a filter coefficient in CCCM that has been described with reference to FIG. 8. According to another embodiment, the relational expression may be replaced with the following relational expression.

$${P}_{n + 1} ( x , y ) = a 0 * {P}_{n} + a 1 * {h}_{n + 1} + a 2 * x + a 3 * y + a 4 * offset$$

In this instance, x and y may represent a x coordinate and a y coordinate of a sample of the current block, respectively.

In addition, a final result value of the above-described filter relational expressions may be one of weights, instead of a prediction sample value of the current block. In this instance, the relational expression may be expressed as shown below.

$$First weight ( x , y ) = a 0 * {P}_{n} + a 1 * {h}_{n + 1} + a 2 * x + a 3 * y + a 4 * offset$$

When two weights (first weight, second weight) are used, the second weight may be 1—the first weight. In this instance, a final prediction sample value may be expressed as shown below.

$$Final prediction sample value = mean value of ( weight \times P 0 + ( 1 - weight ) \times P 2 )$$

The video signal processing device may use the method of generating a prediction block using the relational expression, instead of using a weight flag of MHP. In addition, the video signal processing device may use a method of generating a prediction block using the relational expression in a subordinate mode of a mode that uses a weight flag of MHP.

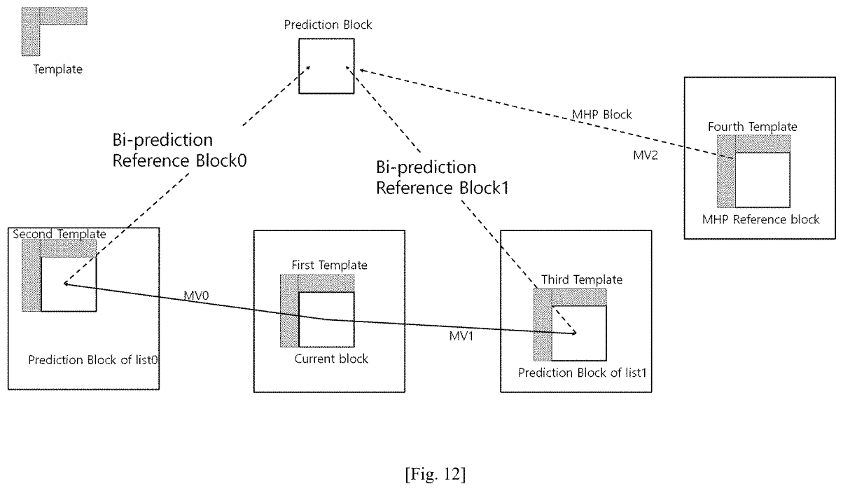

FIG. 12 is a diagram illustrating generation of a prediction block by calculating a weighted sum of reference blocks that a video signal processing device refers to in bi-directional prediction and an MHP reference block when the video signal processing device predicts a current block in bi-directional prediction according to an embodiment of the disclosure.

When the video signal processing device generates a prediction block using a plurality of reference blocks referenced by a plurality of pieces of motion information and a reference block added by MHP, the video signal processing device may generate a prediction block by calculating a weighted sum of the plurality of reference blocks referenced by the plurality of pieces of motion information and the reference block added by MHP. The video signal processing device may derive a relational expression among templates included in the plurality of reference blocks referenced by the plurality of pieces of motion information, a template included in the reference block added by MHP, and a template of a current block, and may predict the current block using the derived relational expression. The video signal processing device may apply a weight based on a sample unit for each reference block or based on a block unit. Therefore, a weight may be different for each reference block but one weight may be applied in each reference block.

A template including a sample adjacent to the current block is referred to as a first template. When bi-directional prediction is used, two pieces of motion information (MV0, MV1) may be used. A template including a sample adjacent to a reference block referenced by MV0 motion information is referred to as a second template. A template including a sample adjacent to a reference block referenced by MV1 motion information is referred to as a third template. A template of a reference block referenced by MV3 that is motion information used for MHP's additional prediction may be referred to as a fourth template. The video signal processing device may obtain coefficients of the relational expression using the above-described first to fourth templates. For example, the relational expression may be expressed as shown in the following equation.

$${P}_{n + 1} = a 0 * {P}_{n} + α 1 * {P}_{n 1} + a 2 * {h}_{n + 1} + a 3 * offset$$

Pₙ₊₁ denotes a sample value of the current block. α₀, α₁, α₂ and α₃ denote filter coefficients. Pₙ denotes a sample value of the reference block referenced by MV0, Pₙ denotes a sample value of the reference block referenced by MV1, and hₙ₊₁ denotes a sample value of the reference block referenced by MV2. Offset may be a median value of a bit depth of an image. When a bitstream is associated with an image with a 10-bit depth, Offset may be 512. According to another embodiment, Offset may be a mean value of samples included in the template of any one of the reference blocks or may be a mean value of samples included in the plurality of reference blocks. In this instance, the number of the plurality of reference blocks may be 3. According to another embodiment, Offset may be a predetermined value.

The video signal processing device may obtain a filter coefficient of the relational equation using the template of the current block and the templates of the plurality of reference blocks. Specifically, the video signal processing device may apply a sample value of the first template to a value of Pₙ₊₁, and may apply sample values of the templates of the plurality of reference blocks to P1, P2 and P3, respectively, so as to obtain filter coefficients. Specifically, the video signal processing device may apply a sample value of the second template to Pₙ, apply a sample value of the third template to Pₙ₁, and may apply a sample value of the fourth template to hₙ₊₁. The video signal processing device may obtain filter coefficients α₀, α₁, α₂, and α₃ according to the embodiments. In this instance, Offset may be determined according to the above-described embodiments. In addition, the operation may be the same as a method of deriving a filter coefficient in CCCM that has been described with reference to FIG. 8.

The video signal processing device may use the method of generating a prediction block using the relational expression, instead of using a weight flag of MHP. In addition, the video signal processing device may use the method of generating a prediction block using the relational expression in a subordinate mode of a mode that uses a weight flag MHP.

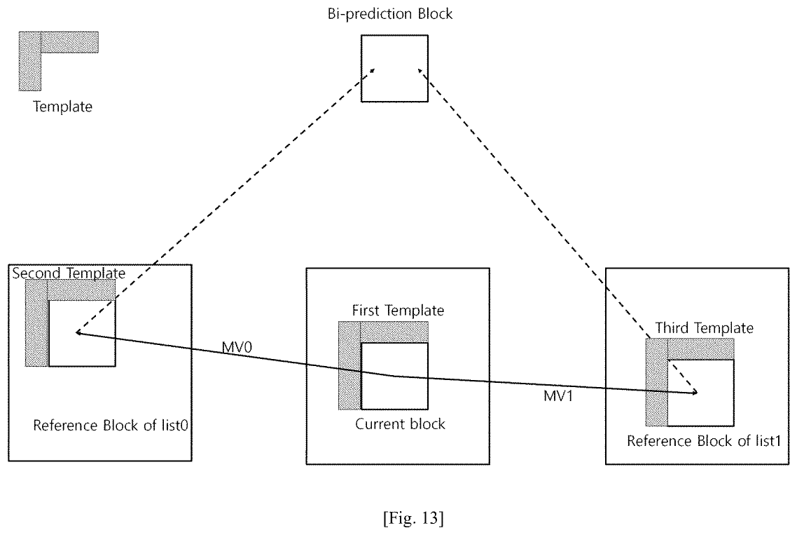

The video signal processing device may use the coefficients of the relational expression, that is, filter coefficients, obtained via the embodiments described with reference to FIGS. 11 and 12, for prediction performed later. In this instance, the prediction may include at least one of MHP prediction, uni-directional prediction, and bi-directional prediction. In addition, the video signal processing device may store, in a separate memory, the coefficients of the relational expression, that is, filter coefficients, obtained via the embodiments described with reference to FIGS. 10 and 13, and may use the same for prediction performed later.

FIG. 13 is a diagram illustrating generation of a prediction block by calculating a weighted sum of reference blocks that a video signal processing device refers to in inter bi-directional prediction when the video signal processing device predicts a current block in inter bi-directional prediction according to an embodiment of the disclosure.

The video signal processing device may generate a prediction block by calculating a weighted sum of reference blocks referenced in inter bi-directional prediction. Specifically, the video signal processing device may derive a relational expression between a template of the current block and a template of the reference block, and may generate a prediction block using the derived relational expression. In this instance, the video signal processing device may apply a weight based on a sample unit or a block unit for each reference block. Therefore, a weight may be different for each reference block but one weight may be applied in each reference block.

In order to obtain a relational expression between the current block and the reference block used for the weighted sum, the video signal processing device may use a template including a sample adjacent to the current block and a template including a sample adjacent to the reference block. The template including the sample adjacent to the current block is referred to as a first template. When inter bi-directional prediction is used, two pieces of motion information (MV0, MV1) may be used. A template including a sample adjacent to a reference block referenced by MV0 motion information is referred to as a second template. A template including a sample adjacent to a reference block referenced by MV1 motion information is referred to as a third template. The video signal processing device may obtain coefficients of the relational expression using the above-described first to third templates. Specifically, the video signal processing device may obtain the relational expression indicating a relationship between the current block and the reference blocks using the CCCM filter relational expression that has been described with reference to (c) of FIG. 8. The video signal processing device according to embodiments may derive a first filter relational expression according to the CCCM filter relational expression form of (c) of FIG. 8 using the first template and the second template. In addition, the video signal processing device may derive a second filter relational expression according to the CCCM filter relational expression form of (c) of FIG. 8 using the first template and the third template. The video signal processing device may generate a first filtered block by applying the first filter relational expression to a first reference block. In addition, the video signal processing device may generate a second filtered block by applying the second filter relational expression to the first reference block. The video signal processing device may generate a prediction block by calculating a weighted sum of the first filtered block and the second filtered block. In this instance, a weight used for the weighted sum may be obtained via the embodiments described with reference to FIG. 9.

In addition, when the embodiments described with reference to FIGS. 11 and 12 and MHP are used together, the video signal processing device may obtain a CCCM filter relational expression using the first template and a template of a reference block added by MHP, and may apply the obtained filter relational expression to the reference block added by MHP, so as to generate a third filtered block. In this instance, the video signal processing device may generate a prediction block by calculating a weighted sum of the third filtered block and one or more filtered blocks. In this instance, the one or more filtered blocks may be obtained by filtering the CCCM filter relational expression of (c) of FIG. 8 to reference blocks referenced by one or more motion vectors. For example, the one or more filtered blocks may include at least one of the above-described first filtered block and second filtered block. In addition, the video signal processing device may obtain the weight applied to the weighted sum according to the embodiments described with reference to FIGS. 11 and 12.

The filter relational expression in the above-described embodiments may be used again for uni-directional prediction or bi-directional prediction performed later. In addition, the filter relational expression in the above-described embodiments may be stored in a separate memory of the video signal processing device.

The embodiments described with reference to FIGS. 10 to 12 may be independently applied to Y, Cb, and Cr that are components of each sample. According to another embodiment, the embodiments described with reference to FIGS. 10 to 12 may be applied to only a luma sample (Y).

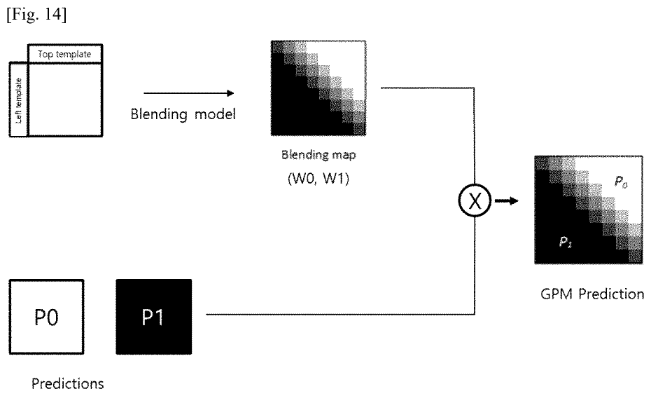

FIG. 14 is a diagram illustrating a method of performing GPM blending by a video signal processing device according to an embodiment of the disclosure.

In a geometric partitioning mode (GPM), the video signal processing device may blend two geometrically partitioned areas so as to predict a sample corresponding to a boundary of the two areas. It is referred to as GPM blending. In this instance, the video signal processing device may obtain a weighted sum of a sample value of a first area and a sample value of a second area by multiplying the sample value of the first area by a first weight (W0) and multiplying the sample value of the second area by a second weight (W1). In addition, an encoding device may include information indicating the first weight and the second weight in a bitstream. A decoding device may obtain information indicating the first weight and the second weight from a bitstream. According to another embodiment, the video signal processing device may obtain a weight using a filter relational expression of FIG. 8 that has been described above. The following equation shows a filter relational expression applied to blending in GPM.

$$w 0 ( x , y ) = ax + by + c ,$$

$$w 1 = 1 - w 0 ( x , y )$$

The video signal processing device may derive a, b, and c that are filter coefficients, using the filter relational expression of FIG. 8 that has been described above. w0(x, y) may be re-expressed as the following relational equation.

$$w 0 ( x , y ) = a * ( P 1 - P 0 ) * x + b * ( P 1 - P 0 ) * y + ( P 1 - P 0 ) * c$$

P0 and P1 may be sample values corresponding to a sample location (x, y) of a template or a predictor block. In addition, when an inter prediction method for P0 and P1 is uni-directional prediction, the values of P0 and P1 may be values modified based on 14-bit internal sample processing accuracy and a bit depth (bitdepth) value. In addition, the filter relational expression used for GPM blending may use 3 filter coefficients. In addition, the filter relational expression used for GPM blending may additionally include a bias term. In this instance, a median value of a bit depth (bitdepth) may be used as a bias term value. Specifically, the video signal processing device may use any one of the following filter relational expressions.

$$w 0 ( x , y ) = a * ( P 1 - P 0 ) * x + b * ( P 1 - P 0 ) * y + ( P 1 - P 0 ) * ( bitdepth >> 1 ) * c$$

$$w 0 ( x , y ) = a * ( P 1 - P 0 ) * x + b * ( P 1 - P 0 ) * y + ( bitdepth >> 1 ) * c$$

$$w 0 ( x , y ) = a * ( P 1 - P 0 ) * x + b * ( P 1 - P 0 ) * y + ( P 1 - P 0 ) * c + ( bitdepth >> 1 ) * d$$

In this instance, bitdepth denotes a bit depth value. In addition, the last relational expression may use 4 filter coefficients. In the relational expressions, the locations/order of P1 and P0 may be changed mutually.

In the disclosure, the above-described methods may be performed by a processor of a decoder or encoder. In addition, the encoder may generate a bitstream that is decoded according to the video signal processing method. In addition, the bitstream generated by the encoder may be stored in a computer readable non-transitory storage medium (storage medium).

Although the disclosure has been described mainly from the perspective of the decoder, the disclosure may be implemented equally in the encoder. The term, parsing, in the disclosure has been described mainly based on a process of obtaining information from a bitstream, and the term may be construed as referring to the generation of the corresponding information in a bitstream from the perspective of the encoder. Therefore, the term, parsing, is not limited to the decoder's operation but is interpreted as an operation of generating a bitstream from the encoder's perspective. In addition, the bitstream may be stored and generated in a computer readable recording medium.

The above-described embodiments of the disclosure may be implemented by various approaches. For example, the embodiments of the disclosure may be implemented by hardware, firmware, software, or a combination thereof.

In the case of implementation by hardware, the method according to embodiments of the disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessor, or the like.

In the case of implementation by firmware or software, the method according to embodiments of the disclosure may be implemented in the form of a module, procedure, or function that performs functions or operations described above. Software code may be stored in a memory, and may be implemented by a processor. The memory may be located inside or outside the processor, and may exchange data with the processor according to various publicly known methods.

Some embodiments may be implemented in the form of a recording medium including instructions executable by a computer such as a program module implemented by a computer. A computer readable medium may be an available medium accessible by a computer, and may include all of volatile and nonvolatile media, and removeable and unremoveable media. In addition, the computer readable medium may include both a computer storage medium and a communication medium. The computer storage medium may include all of volatile and non-volatile media, and removeable and unremoveable media which are embodied by a method or technology for storing information such as computer readable instructions, data structures, program modules, or other data. The communication medium may include other data of a modulated data signal such as computer readable instructions, data structures or program modules, or other transmission mechanism, and may include an information transfer medium.

The above-described descriptions of the disclosure are provided for the illustrative purpose, and it would be apparent that those skilled in the art would easily make modifications in other embodiments without changing technical ideas or essential features of the disclosure. Therefore, it should be understood that the above-described embodiments are provided for the illustrative purposes in every aspect, and are not limited to the description. For example, components described as an integrated form may be embodied as dispersed components, or components described as dispersed components may be embodied as an integrated form.

The scope of the disclosure should be construed based on the claims provided below, rather than the detailed descriptions, and all modifications or changes derived from the meaning and the scope of the claims and their equivalents should be construed as being in the scope of the disclosure.

1. A decoding device for decoding a video signal, the decoding device comprising a processor,
wherein the processor is configured to:
obtain a relational expression between a template of at least one reference block referenced by at least one piece of motion information and a template of a current block; and
generate a prediction block, based on the relational expression, the reference block, and the current block,
wherein the template of the reference block comprises a sample adjacent to the reference block according to a predetermined form, and
wherein the template of the current block comprises a sample adjacent to the current block according to predetermined form.

2. The decoding device of claim 1, wherein the at least one piece of motion information comprises two or more pieces of motion information, and
wherein the at least one reference block comprises two or more blocks, and
wherein the processor is configured to perform a weighted sum of sample values of each of prediction block corresponding to the two or more blocks by using the relational expression.

3. The decoding device of claim 1, wherein the at least one reference block comprises a reference block referenced by multi-hypothesis prediction (MHP).

4. The decoding device of claim 1, wherein the relational expression is a relational expression comprising a plurality of filter coefficients.

5. The decoding device of claim 1, wherein the at least one reference block is included in a current picture comprising the current block.

6. The decoding device of claim 1, wherein the at least one reference block is included in a different picture from a current picture comprising the current block.

7. An encoding device for encoding a video signal, the encoding device comprising a processor,
wherein the processor is configured to:
obtain a relational expression between a template of at least one reference block referenced by at least one piece of motion information and a template of a current block; and
generate a prediction block, based on the relational expression, the reference block, and the current block,
wherein the template of the reference block comprises a sample adjacent to the reference block according to a predetermined form, and
wherein the template of the current block comprises a sample adjacent to the current block according to the predetermined form.

8. The encoding device of claim 7, wherein the at least one piece of motion information comprises two or more pieces of motion information, and
wherein the at least one reference block comprises two or more blocks, and
wherein the processor is configured to perform a weighted sum of sample values of each of prediction block corresponding to the two or more blocks by using the relational expression.

9. The encoding device of claim 7, wherein the at least one reference block comprises a reference block referenced by multi-hypothesis prediction (MHP).

10. The encoding device of claim 7, wherein the relational expression is a relational expression comprising a plurality of filter coefficients.

11. The encoding device of claim 7, wherein the at least one reference block is included in a current picture comprising the current block.

12. The encoding device of claim 7, wherein the at least one reference block is included in a different picture from a current picture comprising the current block.

13. A computer-readable non-transitory storage medium storing a bitstream, the bitstream being decoded according to a decoding method,
wherein the decoding method comprises:
obtaining a relational expression between a template of at least one reference block referenced by at least one piece of motion information and a template of a current block; and
generating a prediction block, based on the relational expression, the reference block, and the current block,
wherein the template of the reference block comprises a sample adjacent to the reference block according to a predetermined form, and
wherein the template of the current block comprises a sample adjacent to the current block according to the predetermined form.

14. A decoding method for decoding a video signal, the method comprising:
obtaining a relational expression between a template of at least one reference block referenced by at least one piece of motion information and a template of a current block; and
generating a prediction block, based on the relational expression, the reference block, and the current block,
wherein the template of the reference block comprises a sample adjacent to the reference block according to a predetermined form, and
wherein the template of the current block comprises a sample adjacent to the current block according to the predetermined form.
